(19) United States
(12) Patent Application Publication
(10) Pub. No.: US 2023/0362940 A1
(43) Pub. Date: Nov. 9, 2023

(54) METHODS, APPARATUS AND SYSTEMS FOR UPLINK CONTROL INFORMATION TRANSMISSION

(71) Applicant: ZTE CORPORATION, Shenzhen (CN)

(72) Inventors: Chunli Liang, Shenzhen (CN); Peng Hao, Shenzhen (CN); Xianghui Han, Shenzhen (CN)

(73) Assignee: ZTE CORPORATION, Shenzhen (CN)

(21) Appl. No.: 18/218,872

(22) Filed: Jul. 6, 2023

Related U.S. Application Data
(63) Continuation of application No. PCT/CN2021/071690, filed on Jan. 14, 2021.

(51) Int. Cl. H04W 72/1268; H04L 27/26; H04W 72/21

(52) U.S. Cl. CPC H04W 72/21; H04L 27/2605; H04W 72/1268

(57) ABSTRACT

Methods, apparatus and systems for uplink control information transmission in a wireless communication are disclosed. In one embodiment, a method performed by a wireless communication device is disclosed. The method comprises: determining a number based on uplink control information (UCI); selecting a sequence from a sequence pool based on the number, wherein the sequence pool comprises a plurality of processed sequences each of which is generated based on a modulation and a post-modulation processing; and transmitting the UCI carried on the sequence to a wireless communication node.

### TECHNICAL FIELD

The disclosure relates generally to wireless communications and, more particularly, to methods, apparatus and systems for uplink control information transmission in a wireless communication.

### BACKGROUND

There is an increasing demand for fourth generation of mobile communication technology (4G, the 4th Generation mobile communication technology), Long-term evolution (LTE, Long-Term Evolution), Advanced long-term evolution (LTE-Advanced/LTE-A, Long-Term Evolution Advanced) and fifth-generation mobile communication technology (5G, the 5th Generation mobile communication technology). The 4G and 5G systems tend to support enhanced mobile broadband, ultra-high reliability, ultra-low latency transmission, and massive connectivity.

As fundamental building components to enable a 5G new radio (NR) system, the Physical Uplink Control Channel (PUCCH) and/or the Physical Uplink Shared Channel (PUSCH) are utilized to convey Uplink Control Information (UCI). In coverage enhancement scenarios, a low peak-to-average power ratio (PAPR) property of a transmission signal, e.g. the PUCCH and/or the PUSCH, is very important because it can enable power boosting, where a higher transmit power means a larger coverage. Although a π/2-binary phase shift keying (π/2-BPSK) modulation can be used for PUCCH/PUSCH transmission, there is no existing solution to further lower PAPR for PUCCH/PUSCH transmission in view of coverage enhancement.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a method performed by a wireless communication device is disclosed. The method comprises: determining a number based on uplink control information (UCI); selecting a sequence from a sequence pool based on the number, wherein the sequence pool comprises a plurality of processed sequences each of which is generated based on a modulation and a post-modulation processing; and transmitting the UCI carried on the sequence to a wireless communication node.

In another embodiment, a method performed by a wireless communication node is disclosed. The method comprises receiving, from a wireless communication device, uplink control information (UCI) carried on a sequence. The sequence is selected from a sequence pool based on a number corresponding to the UCI. The sequence pool comprises a plurality of processed sequences each of which is generated based on a modulation and a post-modulation processing.

In a different embodiment, a wireless communication node configured to carry out a disclosed method in some embodiment is disclosed. In yet another embodiment, a wireless communication device configured to carry out a disclosed method in some embodiment is disclosed. In still another embodiment, a non-transitory computer-readable medium having stored thereon computer-executable instructions for carrying out a disclosed method in some embodiment is disclosed.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader’s understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates an exemplary communication network in which techniques disclosed herein may be implemented, in accordance with an embodiment of the present disclosure.

FIG. 2 illustrates a block diagram of a base station (BS), in accordance with some embodiments of the present disclosure.

FIG. 3 illustrates a flow chart for a method performed by a BS, in accordance with some embodiments of the present disclosure.

FIG. 4 illustrates a block diagram of a user equipment (UE), in accordance with some embodiments of the present disclosure.

FIG. 5 illustrates a flow chart for a method performed by a UE, in accordance with some embodiments of the present disclosure.

FIG. 6 illustrates an exemplary resource block for a PUCCH transmission, in accordance with some embodiments of the present disclosure.

FIG. 7 illustrates a flow chart of a method for mapping resources for UCI transmission, in accordance with some embodiments of the present disclosure.

FIG. 8 illustrates a flow chart of a method for generating a sequence pool for UCI transmission, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

A typical wireless communication network includes one or more base stations (typically known as a “BS”) that each provides geographical radio coverage, and one or more wireless user equipment devices (typically known as a “UE”) that can transmit and receive data within the radio coverage. In the wireless communication network, a BS and a UE can communicate with each other via a communication link, e.g., via a downlink (DL) radio frame from the BS to the UE or via an uplink (UL) radio frame from the UE to the BS.

The present disclosure provides methods and systems and devices for uplink control information (UCI) transmissions on low PAPR sequence based physical uplink control channel (PUCCH) in mobile communication technology, including 5th Generation (5G) and New Radio (NR) communication systems. While the descriptions herein focus on PUCCH, the methods and systems disclosed herein can also be applied to physical uplink shared channel (PUSCH).

A UCI may include information about: a HARQ-ACK (Hybrid Automated Repeat Request-Acknowledgement) feedback in response to downlink data transmission; a Scheduling Request (SR) which is used to request resource for uplink data transmission; and/or a Channel State Information (CSI) report which is used for link adaptation and downlink data scheduling. The CSI report may include Channel Quality Indicator (CQI), Pre-coding Matrix Indicator (PMI), Rank Indicator (RI), Layer Indicator (LI) and/or beam related information.

A PUCCH may be transmitted in one or more Physical Resource Blocks (PRB) at the edges of the system bandwidth, following a mirrored pattern with slot level frequency hopping within a subframe, so as to maximize the frequency diversity. In a NR system, more flexible PUCCH structures can be considered towards targeting different applications and use cases, especially for supporting low latency application such as ultra-reliable low-latency communication (URLLC). When a UE is not transmitting on the PUSCH, the UE can transmit UCI in a PUCCH using one of the following formats. PUCCH format 0 means: the transmission is over 1 symbol or 2 symbols, and/or the number of HARQ-ACK information bits with positive or negative SR (HARQ-ACK/SR bits) is 1 or 2. PUCCH format 1 means: the transmission is over 4 or more symbols, and/or the number of HARQ-ACK/SR bits is 1 or 2. PUCCH format 2 means: the transmission is over 1 symbol or 2 symbols, and/or the number of UCI bits is more than 2. PUCCH format 3 means: the transmission is over 4 or more symbols, the number of UCI bits is more than 2, and/or the PUCCH resource does not include an orthogonal cover code. PUCCH format 4 means: the transmission is over 4 or more symbols, the number of UCI bits is more than 2, and/or the PUCCH resource includes an orthogonal cover code.

In some embodiments, for PUCCH formats supporting more than 2 bits, two coding schemes are applied depending on the payload size of the UCI, e.g., a block code based on Reed-Muller Codes is applied when the input payload size is between 3 to 11 bits, and Polar codes are used when larger than 11 bits. Since block codes are not the optimal coding scheme at low code rates for small to medium payload, the present teaching advantageously provides enhanced performance in these cases, especially in coverage enhancement scenarios.

The methods disclosed in the present teaching can be implemented in a wireless communication network, where a BS and a UE can communicate with each other via a communication link, e.g., via a downlink radio frame from the BS to the UE or via an uplink radio frame from the UE to the BS. In various embodiments, a BS in the present disclosure can be referred to as a network side and can include, or be implemented as, a next Generation Node B (gNB or gNodeB), an E-UTRAN Node B (eNB or eNodeB), a Transmission/Reception Point (TRP), an Access Point (AP), an AP MLD, a non-terrestrial reception point for satellite/fire balloon/ unmanned aerial vehicle (UAV) communication, a radio transceiver in a vehicle of a vehicle-to-vehicle (V2V) wireless network, etc.; while a UE in the present disclosure can be referred to as a terminal and can include, or be implemented as, a mobile station (MS), a station (STA), a non-AP MLD, a terrestrial device for satellite/fire balloon/ unmanned aerial vehicle (UAV) communication, a radio transceiver in a vehicle of a vehicle-to-vehicle (V2V) wireless network, etc.

In various embodiments of the present teaching, the two ends of a communication, e.g., a BS and a UE, may be described herein as non-limiting examples of “wireless communication node,” and “wireless communication device” respectively, which can practice the methods disclosed herein and may be capable of wireless and/or wired communications, in accordance with various embodiments of the present disclosure.

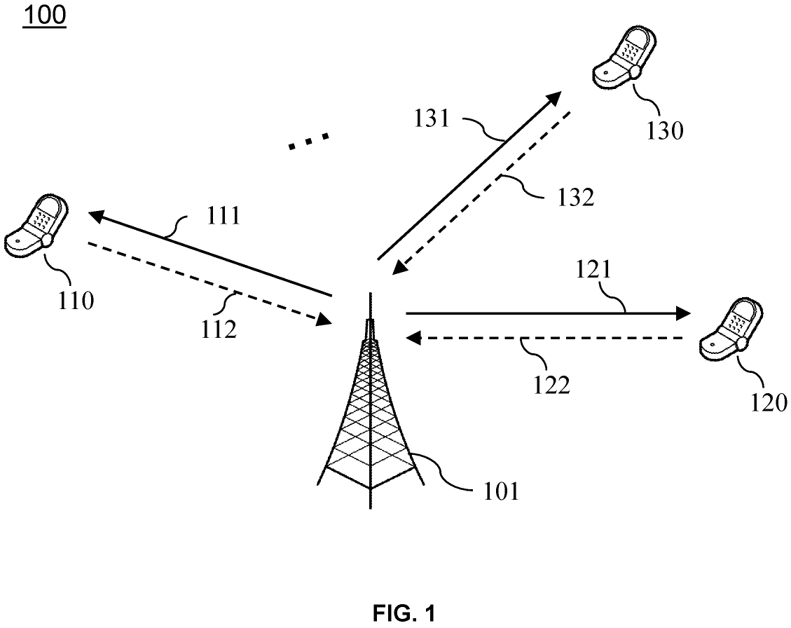

FIG. 1 illustrates an exemplary communication network 100 in which techniques disclosed herein may be implemented, in accordance with an embodiment of the present disclosure. As shown in FIG. 1, the exemplary communication network 100 includes a base station (BS) 101 and a plurality of UEs, e.g. UE 110, UE 120 ... UE 130, where the BS 101 can communicate with the UEs according to wireless protocols. The BS 101 may transmit information on downlink channels 111, 121, 131 to the UE 110, UE 120, UE 130, respectively. The BS 101 may receive information on uplink channels 112, 122, 132 from the UE 110, UE 120, UE 130, respectively.

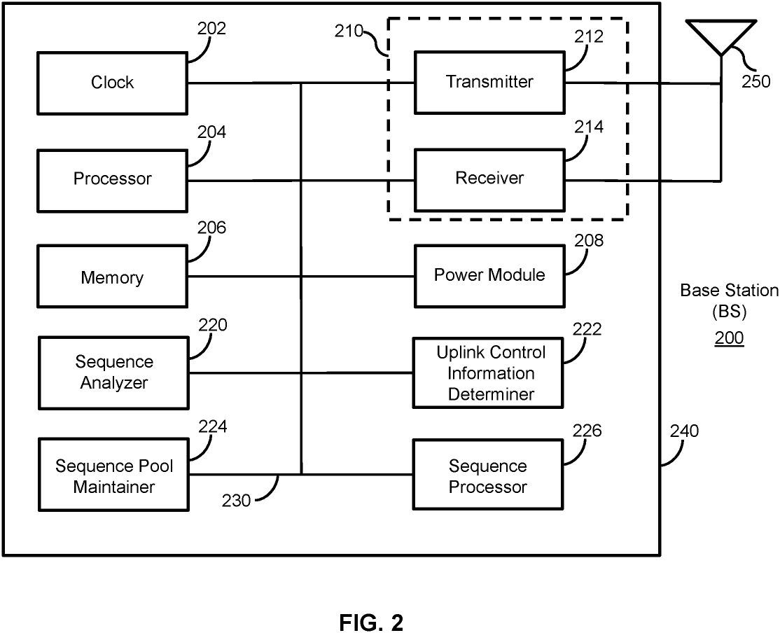

FIG. 2 illustrates a block diagram of a base station (BS) 200, in accordance with some embodiments of the present disclosure. The BS 200 is an example of a node or device that can be configured to implement the various methods described herein. As shown in FIG. 2, the BS 200 includes a housing 240 containing a system clock 202, a processor 204, a memory 206, a transceiver 210 comprising a transmitter 212 and receiver 214, a power module 208, a sequence analyzer 220, an uplink control information determiner 222, a sequence pool maintainer 224, and a sequence processor 226.

In this embodiment, the system clock 202 provides the timing signals to the processor 204 for controlling the timing of all operations of the BS 200. The processor 204 controls the general operation of the BS 200 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions (a.k.a., software) stored in the memory 206 can be executed by the processor 204 to perform the methods described herein. The processor 204 and memory 206 together form a processing system that stores and executes software. As used herein, “software” means any type of instructions, whether referred to as software, firmware, middleware, microcode, etc., which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 210, which includes the transmitter 212 and receiver 214, allows the BS 200 to transmit and receive data to and from a remote device (e.g., a UE or another BS). An antenna 250 is typically attached to the housing 240 and electrically coupled to the transceiver 210. In various embodiments, the BS 200 includes (not shown) multiple transmitters, multiple receivers, and multiple transceivers. In one embodiment, the antenna 250 is replaced with a multi-antenna array 250 that can form a plurality of beams each of which points in a distinct direction. The transmitter 212 can be configured to wirelessly transmit packets having different packet types or functions, such packets being generated by the processor 204. Similarly, the receiver 214 is configured to receive packets having different packet types or functions, and the processor 204 is configured to process packets of a plurality of different packet types. For example, the processor 204 can be configured to determine the type of packet and to process the packet and/or fields of the packet accordingly.

In a wireless communication, the sequence analyzer 220 in the BS 200 may receive, via the receiver 214 from a UE, uplink control information (UCI) carried on a sequence. The sequence is selected by the UE from a sequence pool based on a number corresponding to the UCI. The sequence pool comprises a plurality of processed sequences each of which is generated based on a modulation and a post-modulation processing. In some embodiments, the number is a decimal value converted from information bits of the UCI. In some embodiments, each of the plurality of processed sequences has a length N, which is an integer larger than one. There is a mapping between N elements of the selected sequence and N resource elements in physical uplink control channel (PUCCH) resources. The UCI is received on a PUCCH based on the mapping. The sequence analyzer 220 can analyze the sequence to identify the sequence from the sequence pool. The sequence analyzer 220 may forward the identified sequence to the uplink control information determiner 222. The uplink control information determiner 222 in this example may determine the UCI based on the identified sequence.

The sequence pool maintainer 224 in this example may maintain the sequence pool including a plurality of processed sequences. In some embodiments, the plurality of processed sequences are generated by: generating a plurality of binary sequences each of which has a length N/2; modulating each of the plurality of binary sequences based on a π/2-binary phase shift keying (π/2-BPSK) to generate complex-valued sequences; and processing each of the complex-valued sequences to generate a corresponding one of the plurality of processed sequences. A signal received based on the complex-valued sequence has a higher peak-to-average power ratio (PAPR) than the signal received based on the corresponding processed sequence. That is, the post-modulation processing reduces PAPR of the sequence, when the sequence is carrying an uplink signal.

In some embodiments, each of the plurality of binary sequences is generated based on two pseudo-random sequences; and information bits of the UCI are carried through an initialization of one of the two pseudo-random sequences. In some embodiments, each of the plurality of binary sequences is generated based on a Hash function.

In some embodiments, each binary sequence c(n) of the plurality of binary sequences is generated based on the following equations:

$$c \left(n\right) = S \left(n + 1\right) , n = 0 , 1... \text{N/2 - 1;}$$

$$S \left(k\right) = Y \left(k\right) mod 2 , k = 0 , 1... \text{N/2;}$$

$$Y \left(k\right) = \text{A} Y \left(k \text{- 1}\right) mod \text{D; and}$$

$$Y \left(0\right) = U + \text{X,}$$

wherein U is a decimal value of information bits of the UCI; A, D and X are integers, and mod is the modulus operation.

The sequence processor 226 in this example may perform a post-modulation processing on each of the complex-valued sequences based on several steps. In some embodiments, the sequence processor 226 may be part of the sequence pool maintainer 224. In other embodiments, the sequence processor 226 may be outside of the sequence pool maintainer 224.

In some embodiments, the post-modulation processing includes: inserting a “0” after each element of the complex-valued sequence to form a first sequence; right cyclic shifting the first sequence to obtain a second sequence; left cyclic shifting the first sequence to obtain a third sequence; and generating a processed sequence having the length N based on: the first sequence, the second sequence and the third sequence. For example, the complex-valued sequence may comprise elements x(n), n = 0, 1 ... N/2 - 1; the first sequence is y(n) = [x(0), 0, x(1), 0 ... x(N/2 - 1), 0]; the second sequence is y₊₁ (n) = [0, x(0), 0, x(1) ... 0, x(N/2 - 1)]; the third sequence is y₋₁ (n) = [0, x(1) ... 0, x(N/2 - 1), 0, x(0)]; and the processed sequence z(n) is generated based on:

$$z \left(n\right) = \frac{\sqrt{2}}{2} {y}_{\text{-1}} \left(n\right) + y \left(n\right) + \frac{\sqrt{2}}{2} {y}_{+ 1} \left(n\right) , n = 0 , 1... \text{N} - 1.$$

In some embodiments, the post-modulation processing includes: inserting a “0” before each element of the complex-valued sequence to form a fourth sequence; right cyclic shifting the fourth sequence to obtain a fifth sequence; left cyclic shifting the fourth sequence to obtain a sixth sequence; and generating a processed sequence having the length N based on: the fourth sequence, the fifth sequence and the sixth sequence. For example, the complex-valued sequence comprises elements x(n), n = 0, 1 ... N/2 - 1; the fourth sequence is y(n) = [0, x(0), 0, x(1) ... 0, x(N/2 - 1)]; the fifth sequence is y₊₁ (n) = [x(N/2 - 1), 0, x(0), 0, x(1) ... 0]; the sixth sequence is y₋₁ (n) = [x(0), 0, x(1), 0 ... x(N/2 - 1), 0]; and the processed sequence z(n) is generated based on:

$$z \left(n\right) = \frac{\sqrt{2}}{2} {y}_{\text{-1}} \left(n\right) + y \left(n\right) + \frac{\sqrt{2}}{2} {y}_{+ 1} \left(n\right) , n = 0 , 1 … \text{N} - 1.$$

In some embodiments, the sequence pool is generated by the sequence pool maintainer 224 and shared with UEs performing UCI transmissions to the BS 200. In some embodiments, the sequence pool is generated by a UE, and shared with the BS 200, where the sequence pool maintainer 224 maintains the sequence pool.

The power module 208 can include a power source such as one or more batteries, and a power regulator, to provide regulated power to each of the above-described modules in FIG. 2. In some embodiments, if the BS 200 is coupled to a dedicated external power source (e.g., a wall electrical outlet), the power module 208 can include a transformer and a power regulator.

The various modules discussed above are coupled together by a bus system 230. The bus system 230 can include a data bus and, for example, a power bus, a control signal bus, and/or a status signal bus in addition to the data bus. It is understood that the modules of the BS 200 can be operatively coupled to one another using any suitable techniques and mediums.

Although a number of separate modules or components are illustrated in FIG. 2, persons of ordinary skill in the art will understand that one or more of the modules can be combined or commonly implemented. For example, the processor 204 can implement not only the functionality described above with respect to the processor 204, but also implement the functionality described above with respect to the sequence analyzer 220. Conversely, each of the modules illustrated in FIG. 2 can be implemented using a plurality of separate components or elements.

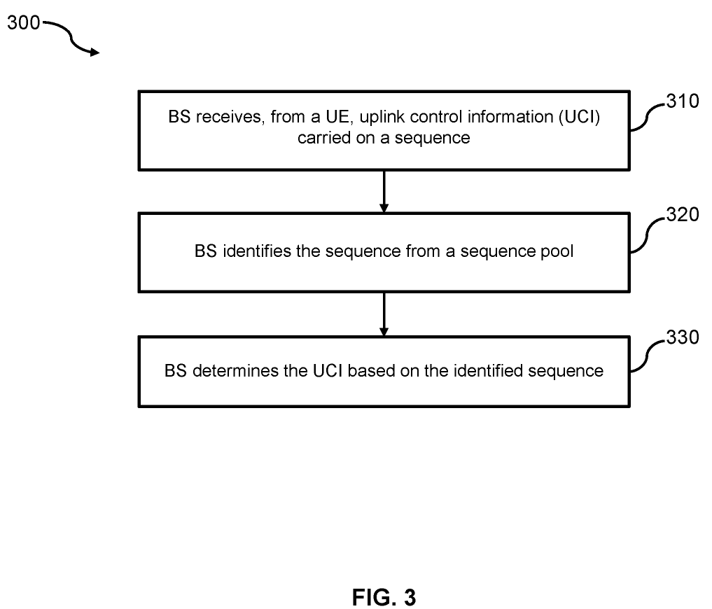

FIG. 3 illustrates a flow chart for a method 300 performed by a BS, e.g. the BS 200 in FIG. 2, in accordance with some embodiments of the present disclosure. At operation 310, the BS receives, from a UE, uplink control information (UCI) carried on a sequence. At operation 320, the BS identifies the sequence from a sequence pool. At operation 330, the BS determines the UCI based on the identified sequence. The order of the operations shown in FIG. 3 may be changed according to different embodiments of the present disclosure.

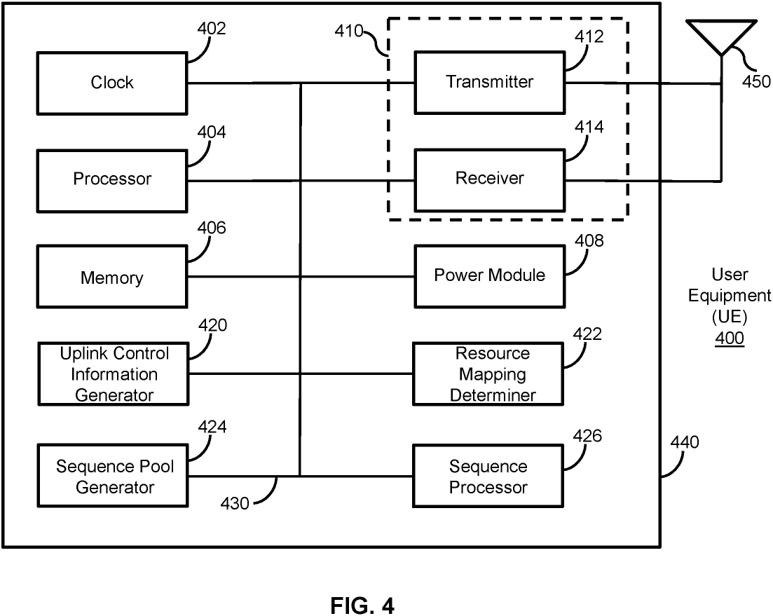

FIG. 4 illustrates a block diagram of a UE 400, in accordance with some embodiments of the present disclosure. The UE 400 is an example of a device that can be configured to implement the various methods described herein. As shown in FIG. 4, the UE 400 includes a housing 440 containing a system clock 402, a processor 404, a memory 406, a transceiver 410 comprising a transmitter 412 and a receiver 414, a power module 408, an uplink control information generator 420, a resource mapping determiner 422, a sequence pool generator 424, and a sequence processor 426.

In this embodiment, the system clock 402, the processor 404, the memory 406, the transceiver 410 and the power module 408 work similarly to the system clock 202, the processor 204, the memory 206, the transceiver 210 and the power module 208 in the BS 200. An antenna 450 or a multi-antenna array 450 is typically attached to the housing 440 and electrically coupled to the transceiver 410.

The uplink control information generator 420 in this example may generate an uplink control information (UCI) to be transmitted to a BS on a PUCCH. The uplink control information generator 420 may forward the UCI to the resource mapping determiner 422 for resource mapping determination.

In some embodiments, the resource mapping determiner 422 may determine a number based on the UCI; and select a sequence from a sequence pool based on the number. The sequence pool comprises a plurality of processed sequences each of which is generated based on a modulation and a post-modulation processing. The resource mapping determiner 422 may transmit, via the transmitter 412 to the BS, the UCI carried on the sequence.

In some embodiments, the resource mapping determiner 422 converts information bits of the UCI to a decimal value. The sequence is selected based on the decimal value. In some embodiments, each of the plurality of processed sequences has a length N, which is an integer larger than one. The resource mapping determiner 422 can map N elements of the selected sequence respectively to N resource elements in physical uplink control channel (PUCCH) resources. The UCI is transmitted on a PUCCH based on the mapping.

The sequence pool generator 424 in this example may generate the sequence pool including a plurality of processed sequences. In some embodiments, the plurality of processed sequences are generated by: generating a plurality of binary sequences each of which has a length N/2; modulating each of the plurality of binary sequences based on a π/2-binary phase shift keying (BPSK) to generate complex-valued sequences; and processing each of the complex-valued sequences to generate a corresponding one of the plurality of processed sequences. A signal transmitted based on the complex-valued sequence has a higher peak-to-average power ratio (PAPR) than the signal transmitted based on the corresponding processed sequence. That is, the post-modulation processing reduces PAPR of the sequence, when the sequence is carrying an uplink signal.

In some embodiments, each of the plurality of binary sequences is generated based on two pseudo-random sequences; and information bits of the UCI are carried through an initialization of one of the two pseudo-random sequences. In some embodiments, each of the plurality of binary sequences is generated based on a Hash function.

In some embodiments, each binary sequence c(n) of the plurality of binary sequences is generated based on the following equations:

$$c \left(n\right) = S \left(n + 1\right) , n = 0 , 1... \text{N/2 - 1;}$$

$$S \left(k\right) = Y \left(k\right) mod 2 , k = 0 , 1... \text{N/2;}$$

$$Y \left(k\right) = \text{A} Y \left(k \text{- 1}\right) mod \text{D; and}$$

$$Y \left(0\right) = U + \text{X,}$$

wherein U is a decimal value of information bits of the UCI; A, D and X are integers, and mod is the modulus operation.

The sequence processor 426 in this example may perform a post-modulation processing on each of the complex-valued sequences based on several steps. In some embodiments, the sequence processor 426 may be part of the sequence pool generator 424. In other embodiments, the sequence processor 426 may be outside of the sequence pool generator 424.

In some embodiments, the post-modulation processing includes: inserting a “0” after each element of the complex-valued sequence to form a first sequence; right cyclic shifting the first sequence to obtain a second sequence; left cyclic shifting the first sequence to obtain a third sequence; and generating a processed sequence having the length N based on: the first sequence, the second sequence and the third sequence. For example, the complex-valued sequence may comprise elements x(n), n = 0, 1 ... N/2 - 1; the first sequence is y(n) = [x(0), 0, x(1), 0 ... x(N/2 - 1), 0]; the second sequence is y₊₁ (n) = [0, x(0), 0, x(1) ... 0, x(N/2 - 1)]; the third sequence is y₋₁ (n) = [0, x(1) ... 0, x(N/2 - 1), 0, x(0)]; and the processed sequence z(n) is generated based on:

$$z \left(n\right) = \frac{\sqrt{2}}{2} {y}_{\text{-1}} \left(n\right) + y \left(n\right) + \frac{\sqrt{2}}{2} {y}_{+ 1} \left(n\right) , n = 0 , 1... \text{N - 1} \text{.}$$

In some embodiments, the post-modulation processing includes: inserting a “0” before each element of the complex-valued sequence to form a fourth sequence; right cyclic shifting the fourth sequence to obtain a fifth sequence; left cyclic shifting the fourth sequence to obtain a sixth sequence; and generating a processed sequence having the length N based on: the fourth sequence, the fifth sequence and the sixth sequence. For example, the complex-valued sequence comprises elements x(n), n = 0, 1 ... N/2 - 1; the fourth sequence is y(n) = [0, x(0), 0, x(1) ... 0, x(N/2 - 1)]; the fifth sequence is y₊₁ (n) = [x(N/2 - 1), 0, x(0), 0, x(1) ... 0]; the sixth sequence is y₋₁ (n) = [x(0), 0, x(1), 0 ... x(N/2 - 1), 0]; and the processed sequence z(n) is generated based on:

$$z \left(n\right) = \frac{\sqrt{2}}{2} {y}_{\text{-1}} \left(n\right) + y \left(n\right) + \frac{\sqrt{2}}{2} {y}_{+ 1} \left(n\right) , n = 0 , 1 … \text{N} - 1.$$

In some embodiments, the sequence pool is generated by the sequence pool generator 424 and shared with the BS associated with the UE 400. In some embodiments, the sequence pool is generated by the BS, and shared with the UE 400.

The various modules discussed above are coupled together by a bus system 430. The bus system 430 can include a data bus and, for example, a power bus, a control signal bus, and/or a status signal bus in addition to the data bus. It is understood that the modules of the UE 400 can be operatively coupled to one another using any suitable techniques and mediums.

Although a number of separate modules or components are illustrated in FIG. 4, persons of ordinary skill in the art will understand that one or more of the modules can be combined or commonly implemented. For example, the processor 404 can implement not only the functionality described above with respect to the processor 404, but also implement the functionality described above with respect to the uplink control information generator 420. Conversely, each of the modules illustrated in FIG. 4 can be implemented using a plurality of separate components or elements.

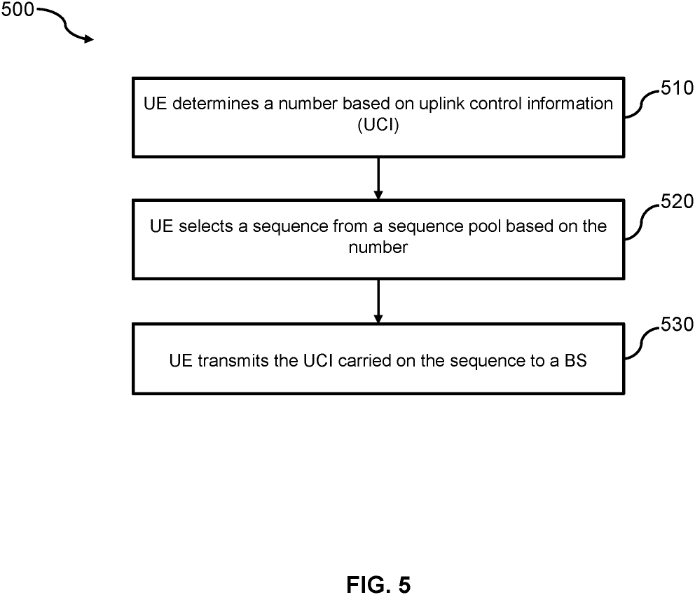

FIG. 5 illustrates a flow chart for a method 500 performed by a UE, e.g. the UE 400 in FIG. 4, in accordance with some embodiments of the present disclosure. At operation 510, the UE determines a number based on uplink control information (UCI). At operation 520, the UE selects a sequence from a sequence pool based on the number. At operation 530, the UE transmits the UCI carried on the sequence to a BS. The order of the operations shown in FIG. 5 may be changed according to different embodiments of the present disclosure.

Different embodiments of the present disclosure will now be described in detail hereinafter. It is noted that the features of the embodiments and examples in the present disclosure may be combined with each other in any manner without conflict.

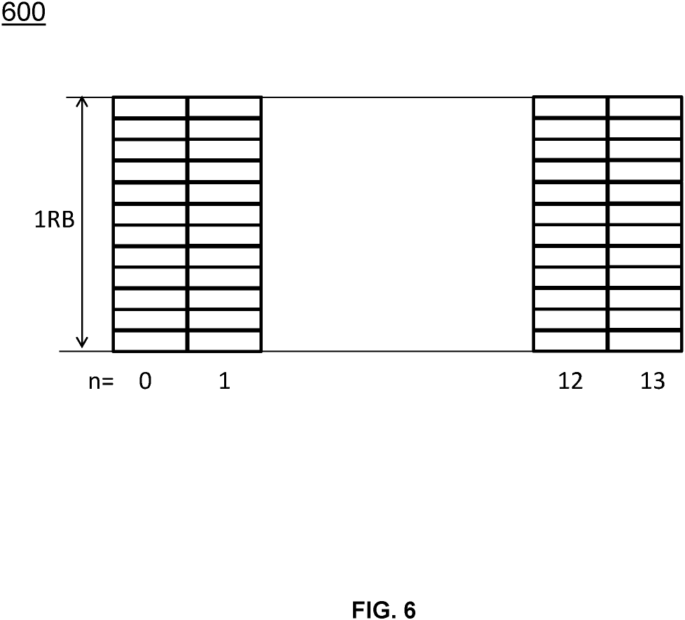

In some embodiments, a PUCCH format can be configured to occupy 1 resource block (RB) including 12 sub-carriers in the frequency-domain and occupy 14 symbols in the time-domain. FIG. 6 illustrates an exemplary resource block 600 for a PUCCH transmission, in accordance with some embodiments of the present disclosure. As shown in the example in FIG. 16, the total available resource elements (RE) for the PUCCH transmission is N = 12* 14 = 168, in this embodiment.

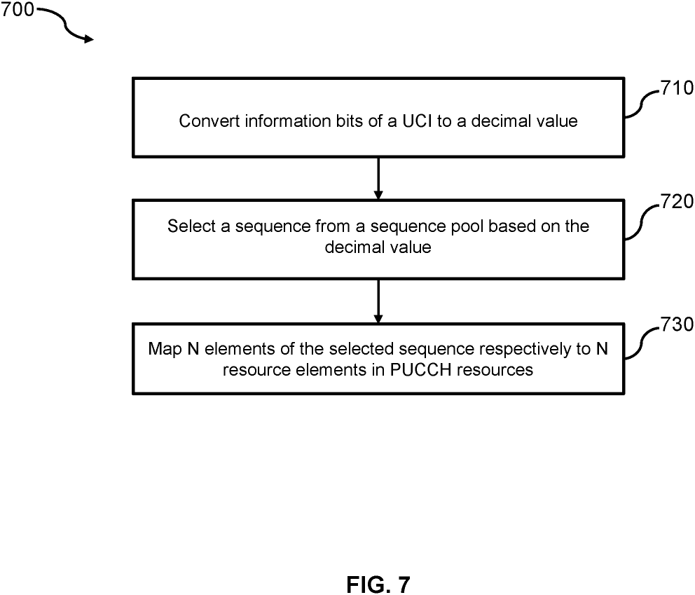

FIG. 7 illustrates a flow chart of a method 700 for mapping resources for UCI transmission, in accordance with some embodiments of the present disclosure. After a UE determines information bit stream of a UCI, the UE can generate a signal to be transmitted for the UCI on a PUCCH based on the method 700. At operation 710, the UE converts information bits of the UCI to a decimal value d. At operation 720, the UE selects the d-th sequence from a sequence pool based on the decimal value d. Each sequence in the sequence pool has a length N. At operation 730, the UE maps N elements of the selected d-th sequence respectively to N resource elements of PUCCH resources, e.g. the N resource elements of the resource block 600 as shown in FIG. 6. The order of the operations shown in FIG. 7 may be changed according to different embodiments of the present disclosure.

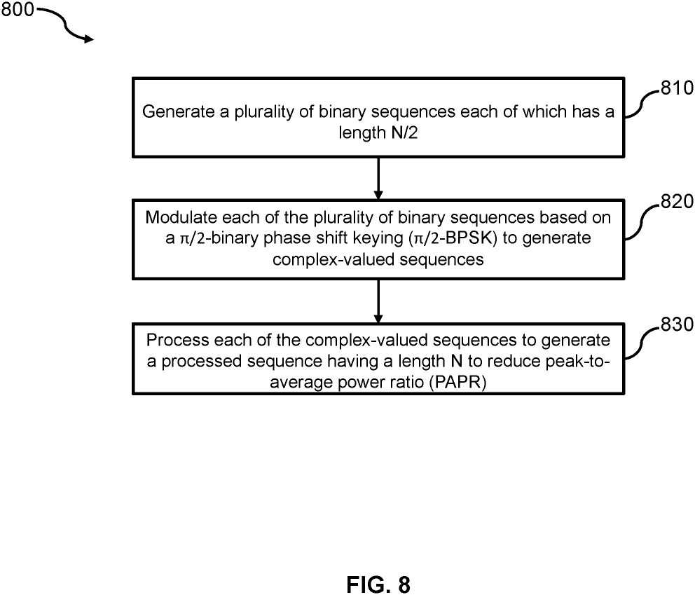

FIG. 8 illustrates a flow chart of a method 800 for generating a sequence pool for UCI transmission, e.g. the sequence pool used in methods shown in FIG. 3, FIG. 5 and FIG. 7, in accordance with some embodiments of the present disclosure. At operation 810, a plurality of binary sequences are generated, where each of the plurality of binary sequences has a length N/2. At operation 820, each of the plurality of binary sequences is modulated based on a π/2-BPSK modulation to generate a complex-valued sequence. As such, a plurality of complex-valued sequences are generated, where each of the plurality of complex-valued sequences has a length N/2. At operation 830, each of the complex-valued sequences is processed to generate a processed sequence having a length N to reduce peak-to-average power ratio (PAPR). The order of the operations shown in FIG. 8 may be changed according to different embodiments of the present disclosure.

In various embodiments, the binary sequences can be generated based on methods including but not limited to: a pseudo-random method and a Hash function based method. The binary sequences and the sequence pool can be generated by either a BS or a UE associated with the BS. Then, the generated sequence pool can be shared by the BS and the UE.

Following the pseudo-random method, pseudo-random sequences can be defined by a length-31 Gold sequence. The output sequence c(n) has a length M_{PN}, where n = 0, 1 ... M_{PN} -1, and can be determined based on the following equations:

$$c \left(n\right) = \left({x}_{1} \left(n + {N}_{c}\right) + {x}_{2} \left(n + {N}_{c}\right)\right) mod 2 \text{;}$$

$${x}_{1} \left(n + 31\right) = \left({x}_{1} \left(n + 3\right) + {x}_{1} \left(n\right)\right) mod 2 \text{;}$$

$${x}_{2} \left(n + 31\right) = \left({x}_{2} \left(n + 3\right) + {x}_{2} \left(n + 2\right) + {x}_{2} \left(n + 1\right) + {x}_{2} \left(n\right)\right) mod 2 \text{,}$$

where N_{c} is an integer, and mod is the modulus operation. In some embodiments, N_{c} = 1600. In some embodiments, each of the sequences x₁(n) and x₂(n) may be a maximum-length sequence (m-sequence), which may be generated from linear feedback shift registers.

The first m-sequence x₁(n) can be initialized with: x₁(0) = 1, x₁(n) = 0, n = 1, 2 ... 30. The initialization of the second m-sequence is denoted by:

$${c}_{\text{init}} = {\sum }_{i = 0}^{30} {x}_{2} \left(i\right) ⋅ {2}^{i} ,$$

where the values of x₂(n) depend on the application of the sequence. In some embodiments, the UCI bits are carried through the initialization of the second m-sequence. For example, the initial value cᵢₙᵢₜ may be determined based on the decimal value d converted from information bits of the UCI. In this case, the length M_{PN} = N/2. In some embodiments, N = 168 as shown in FIG. 6.

Following the Hash function based method, for a given information bit stream of a UCI, the binary sequence c(n) can be determined based on the following equations:

$$c \left(n\right) = S \left(n + 1\right) , n = 0 , 1... \text{N/2 - 1;}$$

$$S \left(k\right) = Y \left(k\right) mod 2 , k = 0 , 1... \text{N/2;}$$

$$Y \left(k\right) = \text{A} Y \left(k \text{- 1}\right) mod \text{D; and}$$

$$Y \left(0\right) = {\left({U}_{\text{info}}\right)}_{\text{dec}} + \text{X,}$$

wherein (U_{info})_{dec} is a decimal value of the information bit stream; A, D and X are integers, and mod is the modulus operation. In one embodiment, A = 39827, D=65537 and X = 1.

The complex-valued sequences x(n) of the output of π/2-BPSK modulation can be expressed as:

$$x \left(n\right) = \frac{{e}^{j \frac{π}{2} \left(n mod 2\right)}}{\sqrt{2}} \left[\left(1 - 2 c \left(n\right)\right) + j \left(1 - 2 c \left(n\right)\right)\right] . \qquad \text{(1)}$$

In some embodiments, the post-modulation processing may include the following operations:
inserting a “0” after each element of the complex-valued sequence x(n) in equation (1) to form a first sequence: y(n) = [x(0), 0, x(1), 0 ... x(N/2 - 1), 0];
right cyclic shifting the first sequence y(n) to obtain a second sequence: y₊₁ (n) = [0, x(0), 0, x(1) ... 0, x(N/2 - 1)];
left cyclic shifting the first sequence y(n) to obtain a third sequence: y₋₁ (n) = [0, x(1) ... 0, x(N/2 - 1), 0, x(0)]; and
generating an output sequence having the length N based on:
$$z \left(n\right) = \frac{\sqrt{2}}{2} {y}_{\text{-1}} \left(n\right) + y \left(n\right) + \frac{\sqrt{2}}{2} {y}_{+ 1} \left(n\right) , n = 0 , 1... \text{N - 1} \text{.}$$

After the post-modulation processing, every two adjacent complex-valued elements in the sequence z(n) have a phase difference no more than π/4. Compared to the complex-valued sequence x(n), whose two adjacent complex-valued elements may have a phase difference as large as π/2, the sequence z(n) has a smaller PAPR when carrying a UCI. As such, each sequence in the sequence pool can be represented by the length N sequence z(n) as described above. The number of sequences in the sequence pool may be related to the number of bits in a UCI. For example, to transmit UCIs having 5 bits, the sequence pool may include 32 (= 2^5) different sequences z(n) to represent the 32 different states of UCI.

In other embodiments, the post-modulation processing may include the following operations:
inserting a “0” before each element of the complex-valued sequence x(n) to form a fourth sequence: y(n) = [0, x(0), 0, x(1) ... 0, x(N/2 - 1)];
right cyclic shifting the fourth sequence y(n) to obtain a fifth sequence: y+1 (n) = [x(N/2 - 1), 0, x(0), 0, x(1) ... 0];
left cyclic shifting the fourth sequence y(n) to obtain a sixth sequence: y-1 (n) = [x(0), 0, x(1), 0 ... x(N/2 - 1), 0]; and
generating an output sequence having the length N based on:
$$z \left(n\right) = \frac{\sqrt{2}}{2} {y}_{\text{-1}} \left(n\right) + y \left(n\right) + \frac{\sqrt{2}}{2} {y}_{+ 1} \left(n\right) , n = 0 , 1... \text{N - 1} \text{.}$$

After the post-modulation processing, every two adjacent complex-valued elements in the sequence z(n) have a phase difference no more than π/4. Compared to the complex-valued sequence x(n), whose two adjacent complex-valued elements may have a phase difference as large as π/2, the sequence z(n) has a smaller PAPR when carrying a UCI. As such, each sequence in the sequence pool can be represented by the length N sequence z(n) as described above. The number of sequences in the sequence pool may be related to the number of bits in a UCI. For example, to transmit UCIs having 5 bits, the sequence pool may include 32 (= 2^5) different sequences z(n) to represent the 32 different states of UCI.

In some embodiments, other post-modulation processing may be performed based on, e.g. circular convolution and/or a filtering operation to reduce PAPR. For example, a filter can be applied to a sequence y(n), which is a sequence obtained by inserting a “0” before or after each element of the complex valued sequence x(n) in equation (1). The filter operation can be expressed as z(n) = y(n) ⊗ h(n), where ⊗ is a circular convolution operation, and the filter coefficient can be expressed as h(n), n = 0, 1 ... N - 1. In one embodiment, the filter coefficient is expressed as:

$$\begin{matrix}h \left(0\right) = 1 , h \left(1\right) = \frac{\sqrt{2}}{2} , h \left(2\right) = 0 , h \left(3\right) = 0 , … , h \left(N - 2\right) = 0 , \\ h \left(N - 1\right) = \frac{\sqrt{2}}{2} .\end{matrix}$$

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method performed by a wireless communication device, the method comprising:
determining a number based on uplink control information (UCI);
selecting a sequence from a sequence pool based on the number, wherein the sequence pool comprises a plurality of processed sequences each of which is generated based on a modulation and a post-modulation processing; and
transmitting the UCI carried on the sequence to a wireless communication node.

2. The method of claim 1, wherein determining the number comprises:
converting information bits of the UCI to a decimal value, wherein the sequence is selected based on the decimal value.

3. The method of claim 1, wherein:
each of the plurality of processed sequences has a length N, which is an integer larger than one;
the method further comprises mapping N elements of the selected sequence respectively to N resource elements in physical uplink control channel (PUCCH) resources; and
the UCI is transmitted on PUCCH based on the mapping.

4. The method of claim 3, wherein the plurality of processed sequences are generated by:
generating a plurality of binary sequences each of which has a length N/2;
modulating each of the plurality of binary sequences based on a π/2-binary phase shift keying (BPSK) to generate complex-valued sequences; and
processing each of the complex-valued sequences to generate a corresponding one of the plurality of processed sequences, wherein a signal transmitted based on the complex-valued sequence has a higher peak-to-average power ratio (PAPR) than the signal transmitted based on the corresponding processed sequence.

5. The method of claim 4, wherein:
each of the plurality of binary sequences is generated based on two pseudo-random sequences; and
information bits of the UCI are carried through an initialization of one of the two pseudo-random sequences.

6. The method of claim 4, wherein:
each of the plurality of binary sequences is generated based on a Hash function.

7. (canceled)

8. The method of claim 4, wherein each of the complex-valued sequences is processed based on:
inserting a “0” after each element of the complex-valued sequence to form a first sequence;
right cyclic shifting the first sequence to obtain a second sequence;
left cyclic shifting the first sequence to obtain a third sequence; and
generating a processed sequence having the length N based on: the first sequence, the second sequence and the third sequence.

9. (canceled)

10. The method of claim 4, wherein each of the complex-valued sequences is processed based on:
inserting a “0” before each element of the complex-valued sequence to form a fourth sequence;
right cyclic shifting the fourth sequence to obtain a fifth sequence;
left cyclic shifting the fourth sequence to obtain a sixth sequence; and
generating a processed sequence having the length N based on: the fourth sequence, the fifth sequence and the sixth sequence.

11. (canceled)

12. The method of claim 4, wherein each of the complex-valued sequences is processed based on:
inserting a “0” after each element of the complex-valued sequence to form a first sequence; and
generating a processed sequence having the length N based on a filter operation using the first sequence and a filter coefficient sequence.

13. (canceled)

14. The method of claim 4, wherein each of the complex-valued sequences is processed based on:
inserting a “0” before each element of the complex-valued sequence to form a second sequence; and
generating a processed sequence having the length N based on a filter operation using the second sequence and a filter coefficient sequence.

15. (canceled)

16. A method performed by a wireless communication node, the method comprising:
receiving, from a wireless communication device, uplink control information (UCI) carried on a sequence, wherein:
the sequence is selected from a sequence pool based on a number corresponding to the UCI, and
the sequence pool comprises a plurality of processed sequences each of which is generated based on a modulation and a post-modulation processing.

17. The method of claim 16, wherein:
the number is a decimal value converted from information bits of the UCI.

18. The method of claim 16, wherein:
each of the plurality of processed sequences has a length N, which is an integer larger than one;
there is a mapping between N elements of the selected sequence and N resource elements in physical uplink control channel (PUCCH) resources;
the UCI is received on PUCCH based on the mapping.

19. The method of claim 18, wherein the plurality of processed sequences are generated by:
generating a plurality of binary sequences each of which has a length N/2;
modulating each of the plurality of binary sequences based on a π/2-binary phase shift keying (BPSK) to generate complex-valued sequences; and
processing each of the complex-valued sequences to generate a corresponding one of the plurality of processed sequences, wherein a signal received based on the complex-valued sequence has a higher peak-to-average power ratio (PAPR) than the signal received based on the corresponding processed sequence.

20. The method of claim 19, wherein:
each of the plurality of binary sequences is generated based on two pseudo-random sequences; and
information bits of the UCI are carried through an initialization of one of the two pseudo-random sequences.

21. (canceled)

22. (canceled)

23. The method of claim 19, wherein each of the complex-valued sequences is processed based on:
inserting a “0” after each element of the complex-valued sequence to form a first sequence;
right cyclic shifting the first sequence to obtain a second sequence;
left cyclic shifting the first sequence to obtain a third sequence; and
generating a processed sequence having the length N based on: the first sequence, the second sequence and the third sequence.

24. (canceled)

25. The method of claim 19, wherein each of the complex-valued sequences is processed based on:
inserting a “0” before each element of the complex-valued sequence to form a fourth sequence;
right cyclic shifting the fourth sequence to obtain a fifth sequence;
left cyclic shifting the fourth sequence to obtain a sixth sequence; and
generating a processed sequence having the length N based on: the fourth sequence, the fifth sequence and the sixth sequence.

26. (canceled)

27. The method of claim 19, wherein each of the complex-valued sequences is processed based on:
inserting a “0” after each element of the complex-valued sequence to form a first sequence; and
generating a processed sequence having the length N based on a filter operation using the first sequence and a filter coefficient sequence.

28. (canceled)

29. The method of claim 19, wherein each of the complex-valued sequences is processed based on:
inserting a “0” before each element of the complex-valued sequence to form a second sequence; and
generating a processed sequence having the length N based on a filter operation using the second sequence and a filter coefficient sequence.

30. (canceled)

31. A wireless communication device, comprising:
a memory operable to store computer-readable instructions; and
a processor circuitry operable to read the computer-readable instructions, the processor circuitry when executing the computer-readable instructions is configured to:
determine a number based on uplink control information (UCI);
select a sequence from a sequence pool based on the number, wherein the sequence pool comprises a plurality of processed sequences each of which is generated based on a modulation and a post-modulation processing; and
transmit the UCI carried on the sequence to a wireless communication node.

32. (canceled)

33. (canceled)
